(19) United States
(12) Patent Application Publication
(10) Pub. No.: US 2007/0150864 A1
(43) Pub. Date: Jun. 28, 2007

(54) Visual-Based Object Oriented Programming Language & System

(76) Inventor: Chee Ying Josiah GOH, Singapore (SG)

Correspondence Address: HORIZON IP PTE LTD, 8 KALLANG SECTOR, EAST WING, 7TH FLOOR, SINGAPORE 349282, 349282, SG

(21) Appl. No.: 11/615,011

(22) Filed: Dec. 22, 2006

Related U.S. Application Data
(60) Provisional application No. 60/597,924, filed on Dec. 26, 2005.

(51) Int. Cl. G06F 9/44

(52) U.S. Cl. 717/113; 717/108

(57) ABSTRACT

A three-dimensional object oriented visual programming language and system for generating object-oriented programs. The system includes a programming environment with a programming interface. The programming interface includes functions for creating and manipulating objects and navigating the different levels of abstractions in the programming environment.

### FIELD OF THE INVENTION

The present invention relates to the field of computer systems and, in particular, to a visual-based programming language and system which aid in the development of an object-oriented program.

### BACKGROUND OF THE INVENTION

A computer program is written using programming languages to describe computational logic or instructions for a computer system to perform. Programming languages can be classified according to their programming paradigms. The two main types of programming paradigms are the procedural approach and the object-oriented approach. There are also other types of programming paradigms, such as imperative programming, component-oriented programming, dataflow programming, functional programming, and constraint programming.

The procedural approach breaks down the domain problem into functions or procedures. Examples of procedural languages include BASIC, COBOL and C. The object-oriented approach, on the other hand, breaks down the domain problem into a collection of objects. Each object is capable of receiving message and processing data, and of sending messages to other objects. Languages such as Small Talk, Java, C++ and ADA support the object-oriented programming paradigm. Most object-oriented programming languages also support the procedural approach.

Object-oriented programming utilizes concepts such as abstraction, encapsulation, inheritance and polymorphism. Abstraction allows the grouping of data and code into meaningful objects in a program. Encapsulation allows “hiding” of data and code in an object such that other objects cannot directly access the hidden data and code. Inheritance allows the reuse of data structures and code logic so that new classes need not be written from scratch. Polymorphism allows different objects to respond to the same message in different ways.

Object-oriented programming languages are generally textually-based. They represent computational logic and instructions using literal statements or text. Textual programming can be performed independent of the programming process, programming languages and development environment. Textual representations, however, are difficult to visualize and understand, making them prone to errors. This makes development of programs, particularly large scale programs, difficult.

From the foregoing discussion, it is desirable to provide an improved programming language and system which aid in the development of software.

### SUMMARY OF THE INVENTION

The present invention relates to a programming language and system. More particularly, the present invention relates to a visual-based programming language and system. In one embodiment, the invention comprises a process for creating an object-oriented-type program. The process includes providing a 3-dimensional (3D) visual programming environment for generating the object-oriented-type program, wherein the visual programming environment comprises a plurality of 3D worlds associated with respective levels of abstraction within a program hierarchy and a visual programming interface within the visual programming environment, the visual programming interface includes functions for navigating the plurality of 3D worlds and for creating and manipulating programming objects using pre-defined templates. Objects for specifying the object-oriented-type program are created using the visual programming interface. The plurality of worlds of the programming environment can be navigated using the visual programming interface.

In another embodiment, a process for creating an object-oriented-type program is disclosed. The process comprises providing a visual programming environment for generating the object-oriented-type program; providing a visual programming interface within the visual programming environment for navigation and creating objects using pre-defined templates; creating a first object of a first type using the visual programming interface, wherein the first object is associated with a first program world; and creating at least a second object of a second type using the visual programming interface, wherein the second object is associated with the first program world

In yet another embodiment, the invention relates to a programming system comprising a 3-dimensional (3D) visual programming environment for generating the object-oriented-type program, wherein the visual programming environment comprises a plurality of 3D worlds associated with respective levels of abstraction within a program hierarchy; and a visual programming interface within the visual programming environment, the visual programming interface comprises functions for navigating the plurality of 3D worlds and for creating and manipulating programming objects using pre-defined templates.

In another embodiment, a visual-based programming language is disclosed. The programming language comprises a programming interface having templates for generating various types of objects associated with different levels of abstractions. The templates includes programming tasks, parameters and characteristics of the objects. Visual icons are associated with created objects.

In other embodiments, a method of compiling a visual-based program is disclosed. The method comprises generating objects which specify a program with a visual-based programming language using a visual programming interface. The visual objects are translated into a textual-based programming language which is compiled into executable code.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows a system for developing an object-oriented program in accordance with one embodiment of the invention;

FIGS. 2-4a-c show a programming interface in accordance with one embodiment of the invention;

FIGS. 5a-c show adding classes and browsing the programming environment using the program interface in accordance with one embodiment of the invention;

FIGS. 6 illustrates the addition of objects in the second level of abstraction in accordance with one embodiment of the invention;

FIGS. 7a-c illustrate the creating of primitives in accordance with one embodiment of the invention;

FIG. 8 shows the addition of a method in a class in accordance with one embodiment of the invention; and

FIGS. 9a-g show the creation of objects in the Method world in accordance with one embodiment of the invention.

### DETAILED DESCRIPTION OF THE INVENTION

The present invention relates generally to a visual-based programming language and system for developing a computer program. In one embodiment, the visual-based programming language comprises an object-oriented programming language. Other types of programming paradigms, such as component-oriented, are also useful. Such programming paradigms will be referred to as object oriented-type programming paradigms or programs.

For purpose of illustration, the invention will be described with reference to an object-oriented programming paradigm. In object-oriented programming, the program comprises a collection of “objects”, each object comprising a block of instructions describing various procedures (“methods”) to be performed by the computer in response to various commands (“messages”) sent to the object. Such operations include, for example, manipulation of stored data, control of visual displays or other outputs, and transmission of one or more messages to invoke methods of other objects. An object can inherit some or all of its interface from another similar object, thereby avoiding the duplication of descriptions of common characteristics. The object is a particular instance of a class. A class is used to group related variables and functions. Related classes and interfaces are further organized into a “package”. Examples of object-oriented computer languages include Smalltalk, C++ and Java.

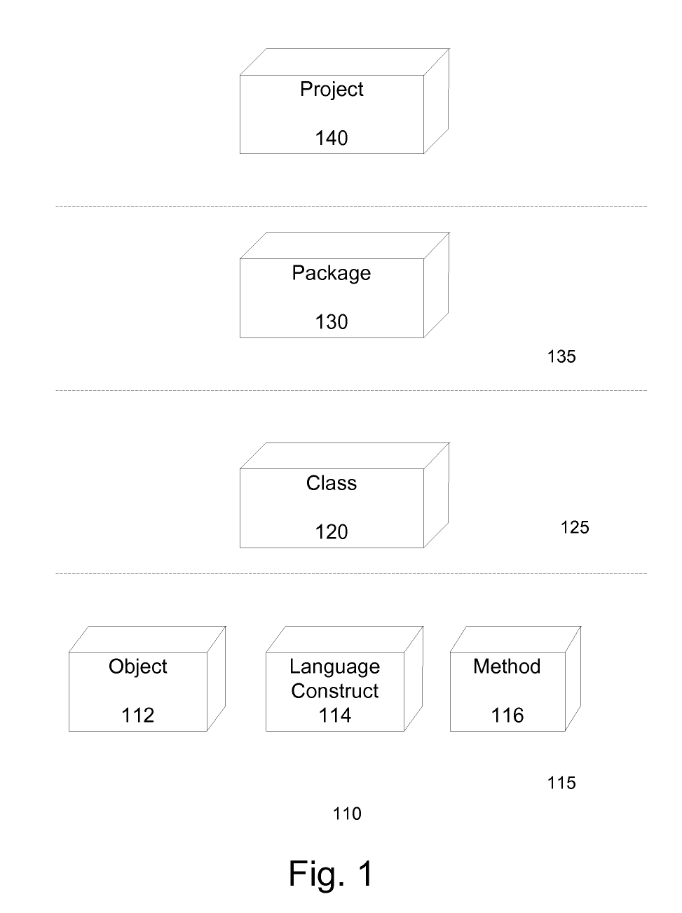

FIG. 1 shows a system for developing an object-oriented type program using visual-based programming language in accordance with one embodiment of the invention. In one embodiment, the system enables an object oriented program to be developed using visual-based programming language. The system provides a programming environment 110. In one embodiment, the programming environment comprises a three-dimensional (3D) visual environment. The 3D environment provides 3D navigation, view and control to the user or programmer for generating a computer program. The 3D environment, in one embodiment, is implemented on a 2D screen. The 3D environment can also be implemented using, for example, virtual reality or mixed reality environments. Other implementations of the 3D environment are also useful. Alternatively, the programming environment can have other numbers of dimensions. For example, the programming environment can comprise a two-dimensional (2D) programming environment.

The system includes a plurality of visual worlds (115, 125, 135) with corresponding levels of abstraction for specifying the program. Although three levels of abstraction are shown for illustration purposes, different numbers of levels of abstraction can also be useful. The levels of abstraction are associated with corresponding types of programming constructs or objects to specify a program. The types of programming constructs can include those used in conventional object oriented type programming paradigms.

In one embodiment, the visual world comprises a three-dimensional (3D) visual world. Worlds having other numbers of dimensions, such as two dimensional (2D) visual worlds or a combination thereof, are also useful. In one embodiment, a world is specified by its own world coordinates. It provides a visual environment for creating and manipulating programming constructs or objects to specify a program. The objects contained in the visual world can be represented by icons. In one embodiment, the programming objects are 3D objects, represented by 3D icons. 3D icons comprise length, breath and depth components. Alternatively, the visual world can contain icons having other number of dimensions, such as 2D. In one embodiment, the programming environment displays one world at a time. Other worlds at other levels of abstraction can be accessed by navigating down or up. Alternatively, the worlds can be simultaneously displayed and/or overlap one another.

Each world provides a level of abstraction defined by the type of programming constructs it contains. Referring to FIG. 1, a first world 115 (e.g., Method World) provides the lowest level of abstraction. It comprises at least one lowest level programming construct. In one embodiment, the lowest level programming constructs can be an object 112, a method 116, or a language construct 114. Objects contain data and code for running the program. An object is an instantiated instance of the higher level programming construct 120 and is created at run-time. For example, an object is an instantiated instance of a class. Methods are self-contained computation logic and instruction within an object. A method is used to manipulate the object and its interaction with other objects. Language constructs contain a “keyword” and are used to specify the code logic.

A second world 125 (e.g. Class World) provides the next higher level of abstraction. It comprises at least one class 120. Classes are templates for building objects. A third world 135 provides the next higher level of abstraction. The third world (e.g. Package World) comprises at least one package 130. Packages contain other child packages and classes. They are generally used to organize classes. The third world can also provide a project 140, which is the programming construct with the highest level of abstraction. A project is a top-level package that does not have any parent packages.

In accordance with one embodiment of the invention, a programming interface is provided within the programming environment. The programming interface provides visual controls for creating, viewing and manipulating programming objects and their respective icons, as well as for navigating the different visual worlds of the programming environment. The controls can be in the form of buttons associated with the desired functions which can be selected. Other types of controls, such as drag down menus, are also useful.

In one embodiment, the programming interface comprises pre-defined templates for creating different types of programming objects or constructs. The templates can be used to form various types of programming objects used in conventional object-oriented type programming languages. For example, templates are provided to create packages, classes, objects, methods, primitives and language constructs. Providing templates for forming other types of programming objects are also useful. The templates can include various features, characteristics or parameters associated with the respective type of programming objects. In one embodiment, the programming interface can include controls for defining templates to create new types of programming objects.

The programming interface places the created objects in selected worlds within the programming environment. Additionally, the programming interface enables the objects to be manipulated and moved after creation. By providing a programming interface in accordance with the invention, syntax error free programs can be created. Furthermore, the visual aspects provide more intuitive programming functions, facilitating software development.

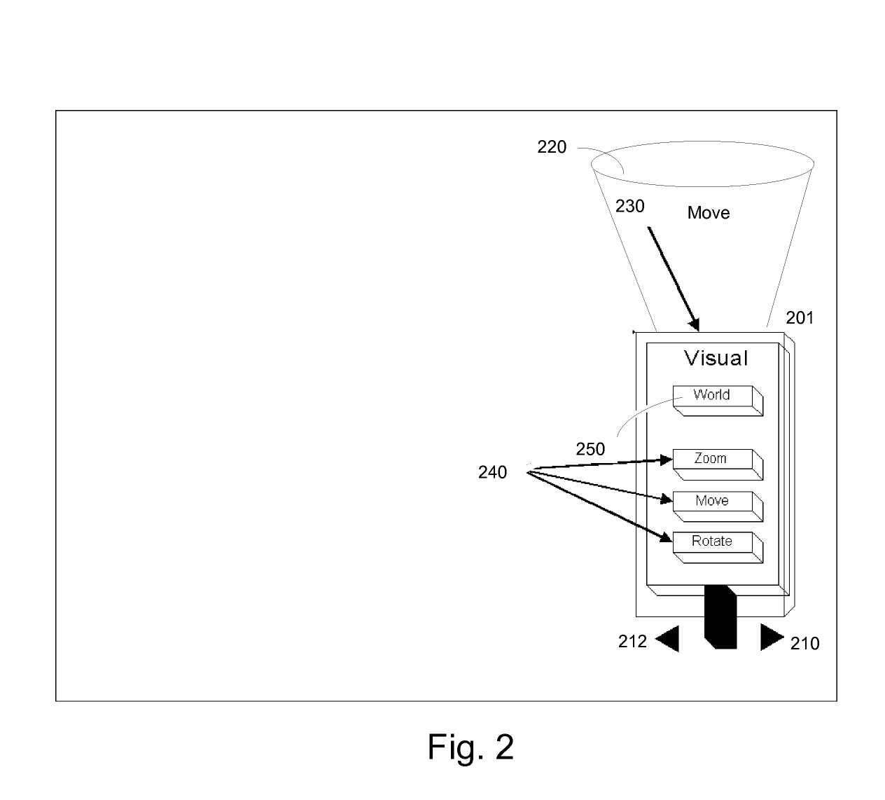

FIG. 2 shows a programming interface 201 in accordance with one embodiment of the invention. In one embodiment, the programming interface comprises a carousel 230. The carousel can be located at a convenient part of the programming environment, for example, at a corner of the computer screen or any other convenient location. The carousal can comprise a plurality of control panels or faces. The different faces comprise buttons for different groups of functions. In one embodiment, the carousel comprises panels for viewing, navigating and objects to be created. For example, the panels enable different worlds to be navigated, viewed, and creating objects therein. Other types of functions or faces can also be provided.

The control panels correspond to different sides of the carousel. By rotating the carousel, the desired control panel or panels can be displayed. For example, 1 or 2 adjacent control panels can be displayed. Control buttons 210 and 212 are provided to control the carousel. For example, the carousel can be rotated to the right by activating icon 210 and to the left by activating button 212. The buttons are preferably 3D. 2D buttons are also useful. Other methods of rotating the carousel can also be provided. For example, rotating the carousel can be achieved by “grabbing and dragging” one face of the carousel. Various types of visual designs can be employed. In one embodiment, the carousel is visually encased by a transparent casing.

In accordance with one embodiment of the invention, the carousel is provided with three control panels, as illustrated by FIGS. 2, 3 and 4a-c. Referring to FIG. 2, the “Visual” control panel of the carousel is shown. The Visual control panel is used to visually manipulate icons and/or worlds. Various types of functions for visually manipulating icons and/or worlds are provided by the Visual control panel. In one embodiment, the Visual control panel comprises zooming, moving and rotating functions. The functions can be invoked by activating or selecting the appropriate buttons 240. In one embodiment, the visual manipulation can be performed on either a selected icon or world. A “world/object” button 250 can be provided to toggle between the 2 modes.

A 3D projection ray 220 can be provided to display information about the function associated with the icon selected. For example, when an icon on the Visual face is activated, the visual manipulation associated with the icon will be performed on the selected icon or world and displayed as text (e.g. “Move”) in the projection ray.

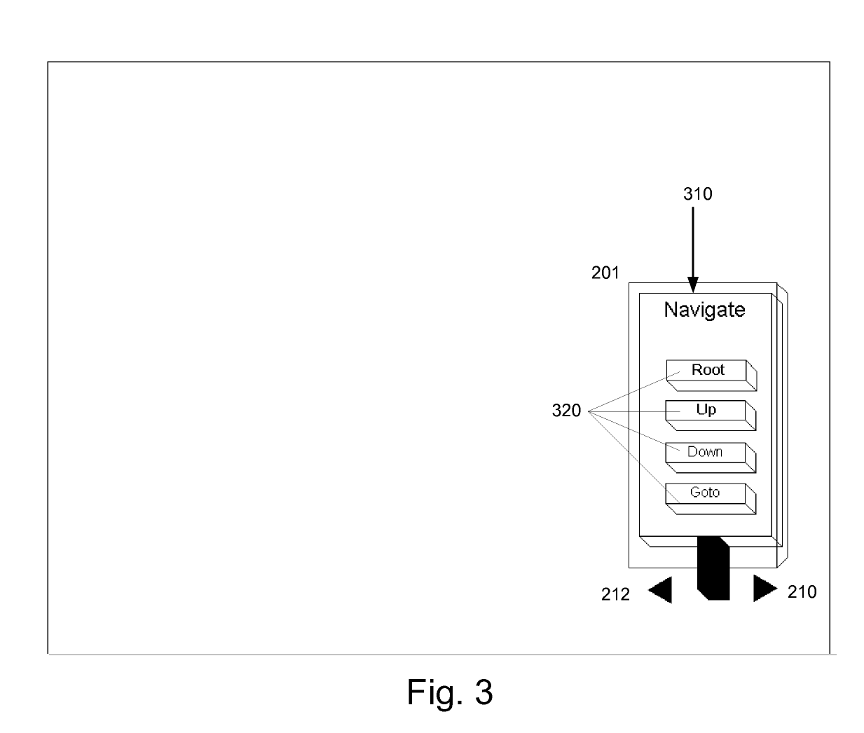

Referring to FIG. 3, a “Navigate” control panel 310 in accordance with one embodiment of the invention is shown. The Navigate control panel contains functions which enable the user to navigate between the different worlds. In one embodiment, the control panel comprises Root, Up, Down and Goto functions. The desired function can be selected by activating the appropriate button 320. The “Root” button allows the user to navigate to the root package of the current project. The “Up” button brings the user one level higher in the hierarchy of the current world. For example, if the user is currently in the Method world, it will bring the user up to the Class World housing the current object. The “Down” button has the reverse effect of bringing the user down to a world containing the current or focused icon. For example, if the user is focusing on a package, the “Down” button will bring the user to the Package World of that package. The “Goto” button will bring the browsing mechanism within the 3D projection ray. For example, available packages in the Package World would be shown in the projection ray. This allows the user to specify and navigate to any Package or Class or Method World conveniently.

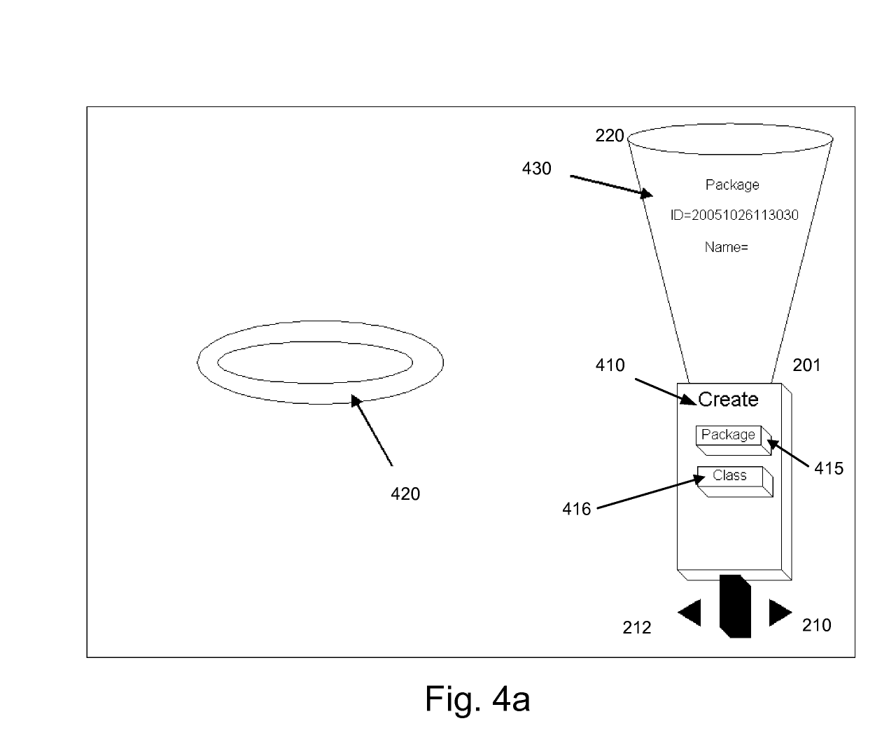

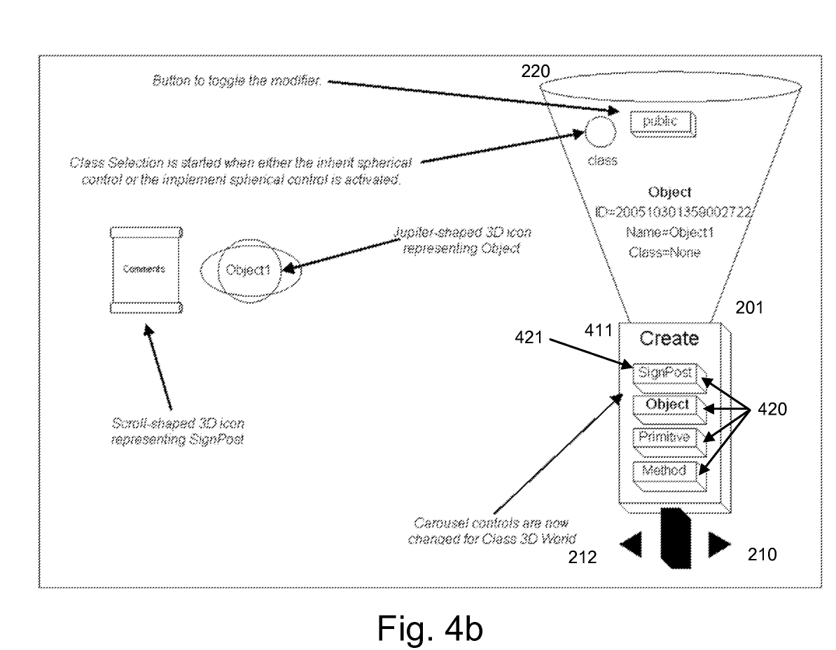

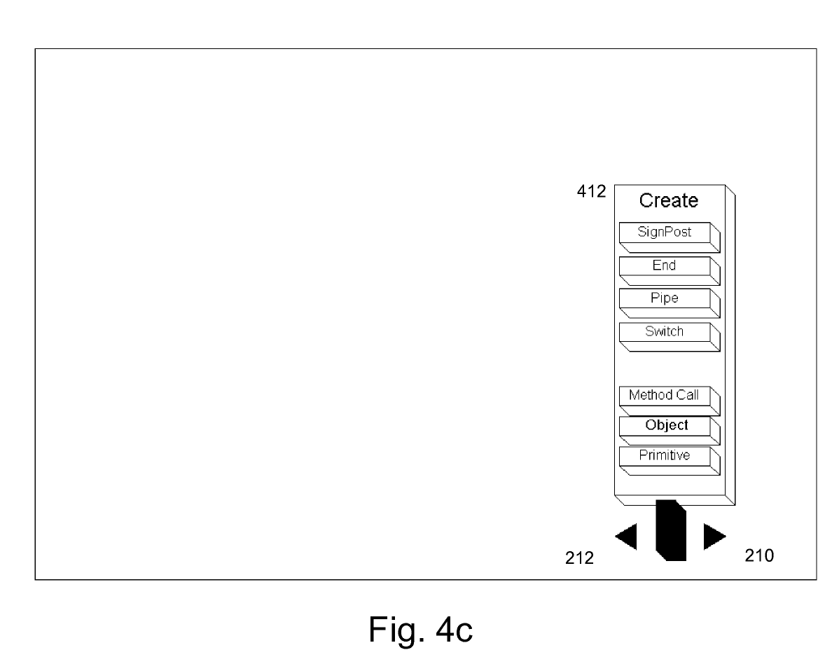

FIGS. 4a-c show Create control panels of the carousal for creating programming constructs, such as those described in FIG. 1. In accordance with one embodiment of the invention, each level of abstraction is provided with a Create control panel. Other configurations, for example, one control panel for all levels of abstraction, can also be useful. As shown in FIG. 4a, a first “Create” control panel 410 of the carousal is shown. The first Create control panel is associated with a first level of abstraction. In one embodiment, the first Create control panel is associated with the highest level of abstraction, for example, enabling user to create programming constructs therein. The first control panel is accessed, for example, when a user is at the Package World. In one embodiment, the first Create control panel contains templates for creating Package and Class constructs. The desired programming construct can be created by selecting or activating the appropriate button (415 and 416). For example, when a new project is created, the Package World is initially empty of all programming objects. The user creates a new package by activating the “Package” button 415 on the carousal. A new package can be represented by a graphical icon 420. The graphical icon, in one embodiment, comprises a 3D icon. 2D icons are also useful. The icon can be any shape, such as doughnut-shaped, cone, spherical, prism or any other shapes. The package is typically created initially with no name.

In one embodiment, the 3D projection ray 220 displays information about the package. The information comprises, for example, the name of the package. Other types of information can also be displayed. The name of the programming construct is used primarily for display purposes and to allow the user to easily identify it. The user can specify the name by activating the package icon 420 and typing the name in the projection ray. In one embodiment, the information further comprises a unique identifier (ID). The identifier is typically generated by the system and is used to uniquely identify the programming construct. This advantageously allows programming constructs to be renamed by the user without causing syntax errors during compilation of the program.

Referring to FIG. 4b, a second Create control panel 411 is shown. The second Create control panel is associated with a second level of abstraction. In one embodiment, the second Create control panel contains functions for creating objects within a class. Accessing the second Create panel can be achieved when a class is selected. The second Create control panel can also be accessed using the Navigate control panel. In one embodiment, the second Create control panel comprises templates for adding different types of pre-defined objects. In one embodiment, the pre-defined types of programming objects include methods, objects, and primitives. Primitives are objects of pre-defined system classes with singular data and no methods. They exist to ease the programming task for simple and commonly used objects. Other types of objects can also be useful. The different types of templates can be selected by activating the appropriate buttons 420. The control panel can also include a function of defining additional types of programming objects.

In one embodiment, a function for adding comments for documentation purposes can be provided. This function can be activated by, for example, selecting the “SignPost” button 421 which creates a SignPost object or icon. Comments can be input into a SignPost icon. Since SignPost objects are not part of the execution syntax, it is not necessary to associate it with an identifier (ID).

Referring to FIG. 4c, a third Create control panel 412 associated with a third level of abstraction is shown. In one embodiment, objects in the third level of abstraction are for the specification of code logic. In one embodiment, the third level of abstraction, for example, comprises Method objects. Accessing the third Create panel can be achieved when a method object is selected. The third Create control panel can also be accessed using the Navigate control panel. In one embodiment, the third Create control panel comprises functions for creating pre-defined objects within the third level of abstraction. In one embodiment, the pre-defined types of objects include objects, primitives, and language constructs. Functions for creating language constructs include “Pipe”, “Switch” and “End”. The Pipe function is used to link objects, conditional execution of computational logic and instruction can be achieved using the Switch function, and End terminates the execution of the programming object. Other functions associated with language constructs can also be provided. Other types of objects are also useful. The control panel can also include a function for defining additional types of class objects. A function for adding comments for documentation purposes can also be provided (e.g., SignPost).

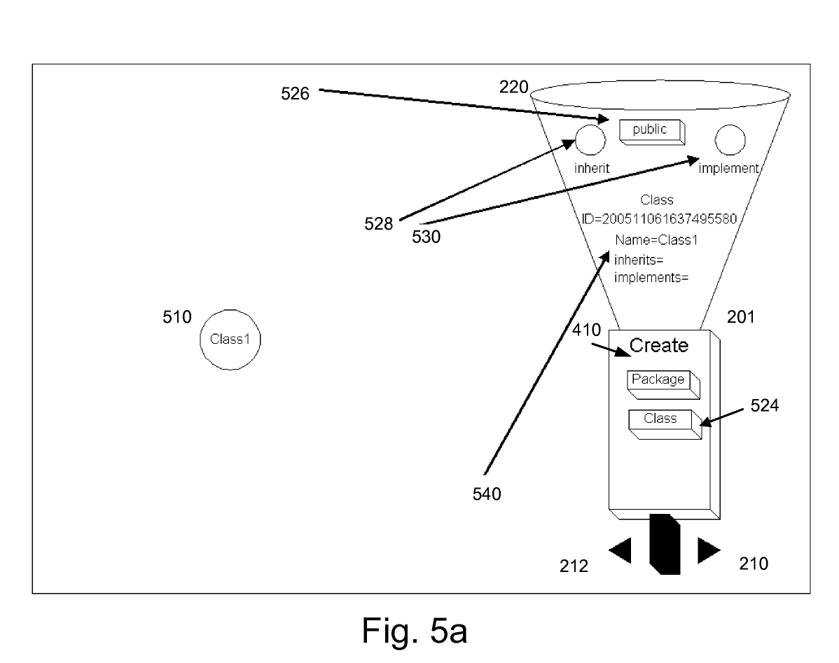

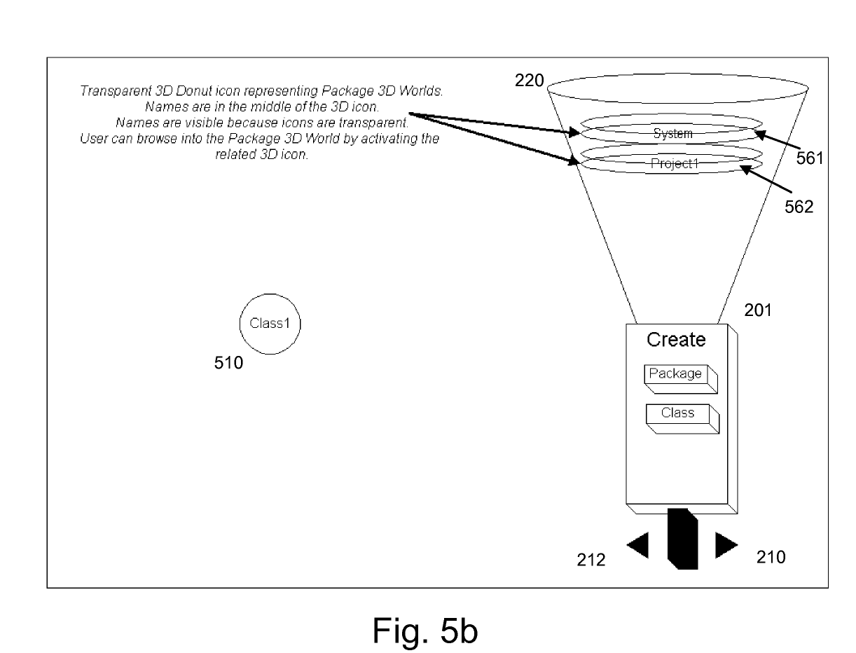

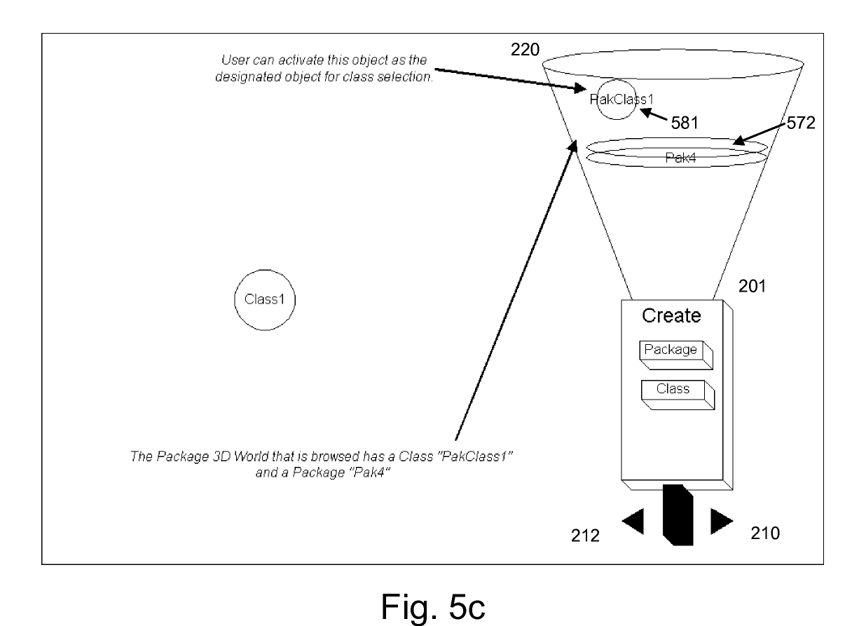

FIGS. 5a-c illustrate adding a class object and browsing the programming environment using the programming interface in accordance with one embodiment of the invention. Referring to FIG. 5a, addition and manipulation of classes in the programming environment is shown. To add a class, the programming interface is rotated as necessary to display the first Create control panel. A new class can be created by activating the “class” button 524. The class can be represented by an icon 510. In one embodiment, information 540 about the class is displayed in the projection ray 220. Displaying the class information at other locations, such as in or near the class icon, is also useful. The user can enter the name of the class (e.g., “Class 1”) by typing beside the “Name” string. Other types of information, such as the unique identifier (ID) of the class and properties of the class, can also be displayed.

In one embodiment, control buttons (526, 528 and 530) for performing various programming tasks are also displayed in the projection ray. The control buttons comprise 3D buttons in one embodiment. 2D buttons, or other types of buttons, are also useful. The control buttons can comprise various shapes, such as spheres, boxes or prisms. Other types of shapes are also useful. In one embodiment, programming tasks performed by the control buttons comprise changing modifiers, adding or deleting class inheritance, and adding or deleting class interfaces. Other types of programming tasks are also useful.

Changing modifiers can be achieved by, for example, activating the modifier button 526. The modifier button can be toggled to, for example, “public”, “abstract” or “final” class modifiers. Other types of class modifiers are also useful. In one embodiment, the button comprises a three dimensional button which can be rotated when selected to the desired modifier. Other types of buttons for toggling or techniques for selecting the different modifiers are also useful. Abstract classes are classes that contain abstract methods and cannot be directly instantiated to create objects. Final classes are classes that cannot be inherited by other classes. The remaining type of classes, which are non-abstract and non-final, are indicated by default as public classes. In one embodiment, all classes are public, even if they are indicated to be “abstract” or “final”. Further, the user can add or delete inheritance or interfaces in a class by activating the “inherit” button 528 and “implement” button 530 respectively. When either the “inherit” button or the “implement” button is activated, a browsing interface can be displayed in the projection ray to allow the user to select the desired class.

FIG. 5b illustrates the programming interface for browsing the programming environment in accordance with one embodiment of the invention. For purpose of illustration, the programming environment includes a class object 510 (e.g., Class 1) created in FIG. 5a. During browsing, the carousel displays the available projects already created in the programming environment. As shown, the programming environment has first and second packages 561 and 562 (e.g., System and Project 1). The packages are represented by ring shaped icons in the projection ray. In one embodiment, the icons are transparent and have their names located therein. A package can be accessed or viewed by selecting its icon. For example, Project 1 package can be accessed by selecting icon 562.

Referring to FIG. 5c, the programming environment is shown after selection of the Project 1 package. The objects of Project 1 are shown in the projection ray. Illustratively, Project 1 includes a package 572 (e.g., Pak4) and a non-final class 581 (e.g., PakClass 1). These objects can be selected by selecting their icons. For example, if the user desires to select the class, it selects the class 581. Alternatively, the user can continue to browse the package 572 within Project 1 to access classes therein.

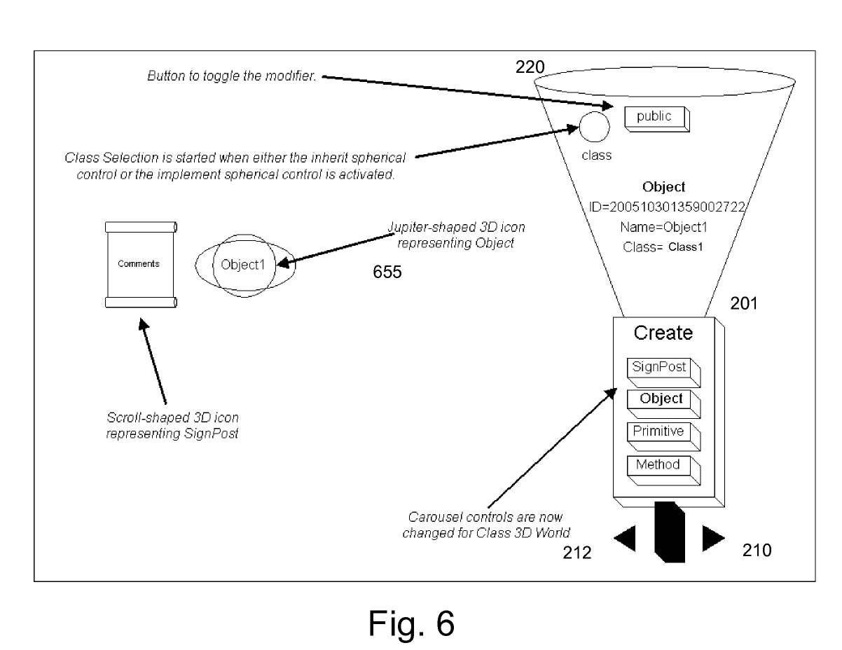

FIG. 6 illustrates the addition of an object in the second level of abstraction in accordance with one embodiment of the invention. As shown, the programming interface displays the second Create control panel, accessing the Class World. To create an object within the class, the Object button is activated. The programming interface creates an object, represented by object icon 655.

The properties and characteristics associated with the object are displayed in the projection ray 220. In one embodiment, the system generates an ID associated with the newly created object. The name of the object can be assigned by the user, for example, Objectl. Initially, the system assigns an object to a pseudo system class (e.g., “None”) when it is first created. Objects belonging to the pseudo system class cannot perform useful programming tasks.

The object is assigned to a legitimate class (e.g., Class 1) by the user, activating the object. To assign the object to a class, the class control button or sphere in the projection ray is selected. Activating the class control button enables browsing of the different levels of abstraction in the programming environment. By being able to browse other levels of abstraction, non-abstract class therein can be selected. Selection of classes, for example, can be performed in a similar manner as selecting class inheritances and class implementations.

An object modifier control button is also provided. The object modifier control button, in one embodiment, is provided in the projection ray. The object modifier control button is used to modify the characteristics of the object. In one embodiment, the modifier can modify the object to be either “public” or “private”. Public objects can be accessed by other packages while private objects can only be accessed from within the same package.

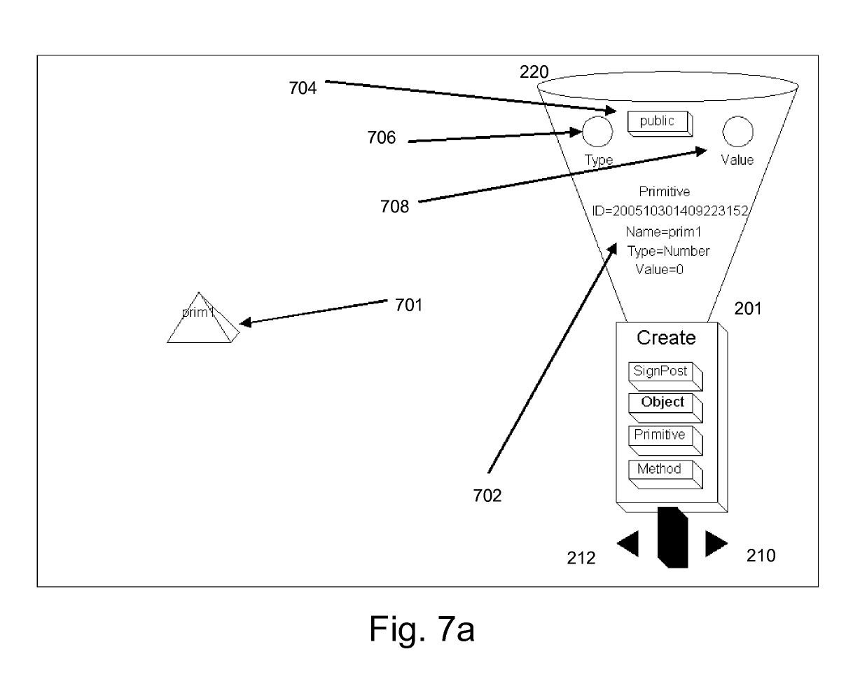

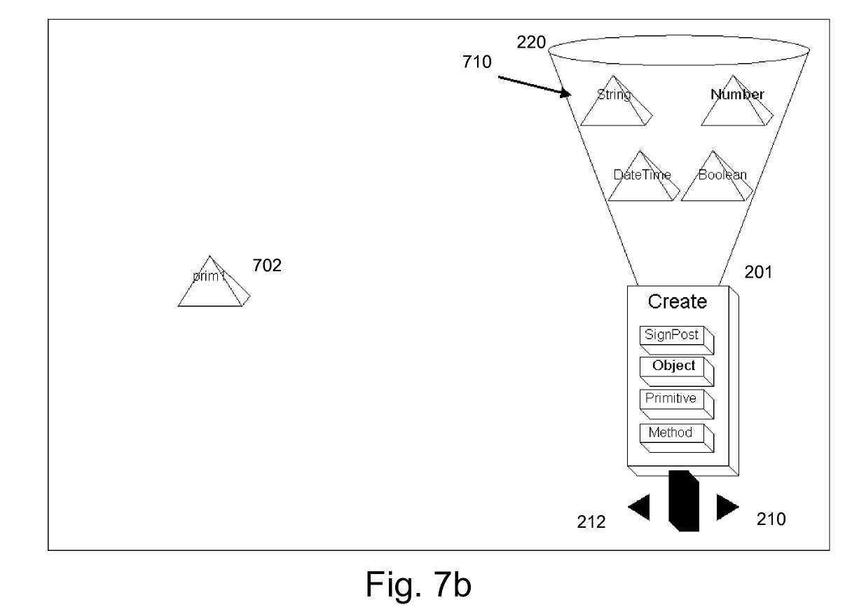

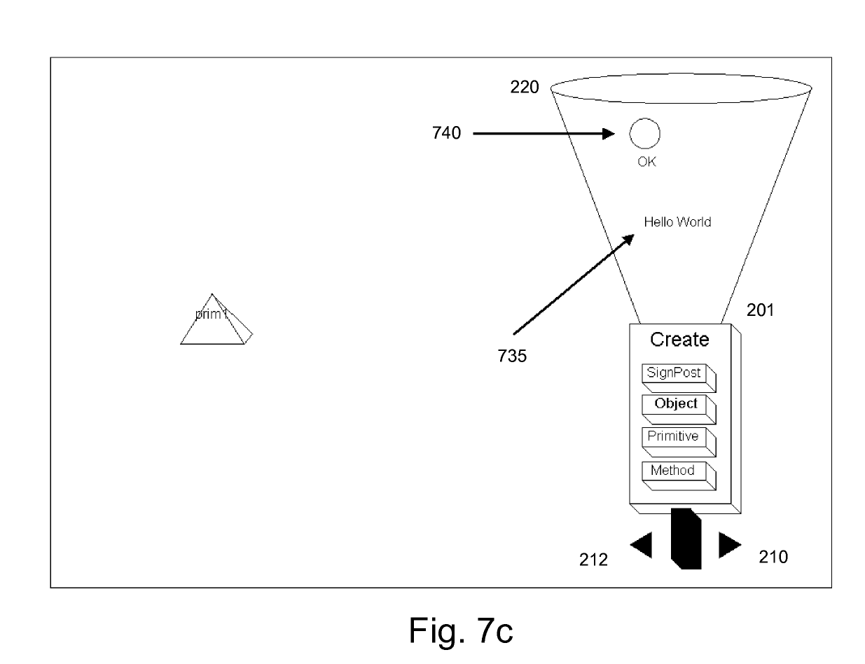

FIG. 7a illustrates the addition of a primitive 701 in the Class World. Primitives are objects of pre-defined system classes. Typically, primitives comprise singular data and no methods. They are generally used to ease the programming task for simple and commonly used objects. In one embodiment, primitives are created by activating the “Primitive” button on the “Create” face of the Carousel. The projection ray 220 displays various types of information 702 of the primitive. The information includes, for example, a unique identifier (ID), the name, type and value of the primitive.

Additionally, the 3D projection ray may display various control buttons for manipulating the primitive. For example, a modifier button 704 can be provided to determine the access control of the primitive. A “Type” button 706 can be provided to select the type of primitives. Typically, there are 4 types of primitives available: “Boolean”, “DateTime”, “Number” and “String”. “Boolean” primitives represent a variable that is either true or false. “DateTime” primitives store date/time data for manipulation in the program. “Number” primitives store numeric data for manipulation in the program. “String” primitives store string data for manipulation in the program. The primitives can be displayed in the projection ray, as shown in FIG. 7b. In one embodiment, 4 icons 710 are displayed when the “Type” button is activated. The user may select the primitive type by activating one of these icons. Other methods of selecting the type of primitive are also useful.

Referring back to FIG. 7a, a “Value” button 708 can be provided for entering the value of the primitive. In one embodiment, when the user activates the “Value button”, the projection ray 220 will provide the controls to allow the user to enter the values. For example, FIG. 7c shows the 3D projection ray after activating the “Value” button in FIG. 7a. The user can enter the value (for e.g., “Hello World”) and activate the “OK” button 740 to finish the entry of the value. The value can be checked by the program to ensure that it falls within an acceptable range. Different primitive types may have different acceptable ranges.

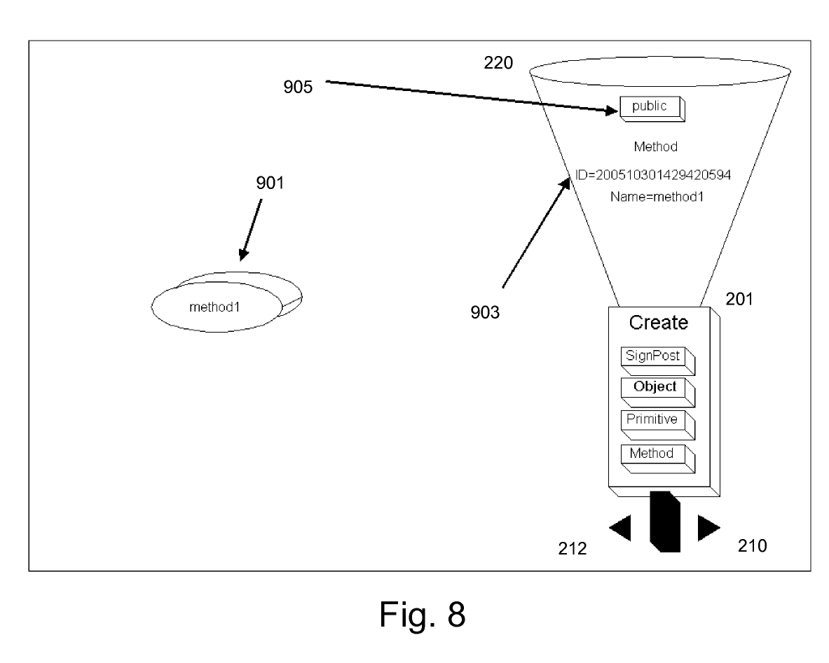

FIG. 8 shows the addition of a method 901 into a class. Methods typically contain computational logic and instructions of how the object responds to a message or method call. A method may contain parameter objects and/or primitives. This enables the object to respond differently based on the parameter objects and/or primitives in the method call. Parameters may be passed by reference or value, as well known to those skilled in the art. Preferably, parameters are passed by reference.

A method can be created by activating the “Method” button on the “Create” face of the Carousel. The name of the method (e.g. “method1”) can be specified after activating the “Method” button. The projection ray 220 displays various types of information 903 of the method. For example, the unique identifier (ID) and name of the method may be displayed. Control buttons may also be provided in the projection ray. For example, a modifier control button 905 can be provided to allow the user to specify the modifier of the method.

In one embodiment, the Method 3D World is displayed whenever the Method 3D icon is the focused object and the “Down” carousel button is activated. The following paragraphs describe the process of creating objects, primitives and language constructs within a Method 3D World for specification of code logic.

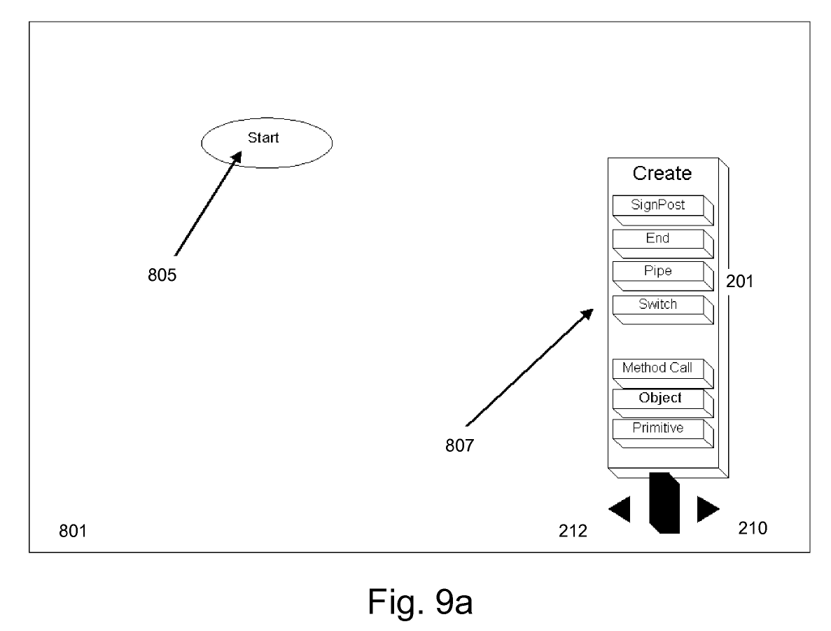

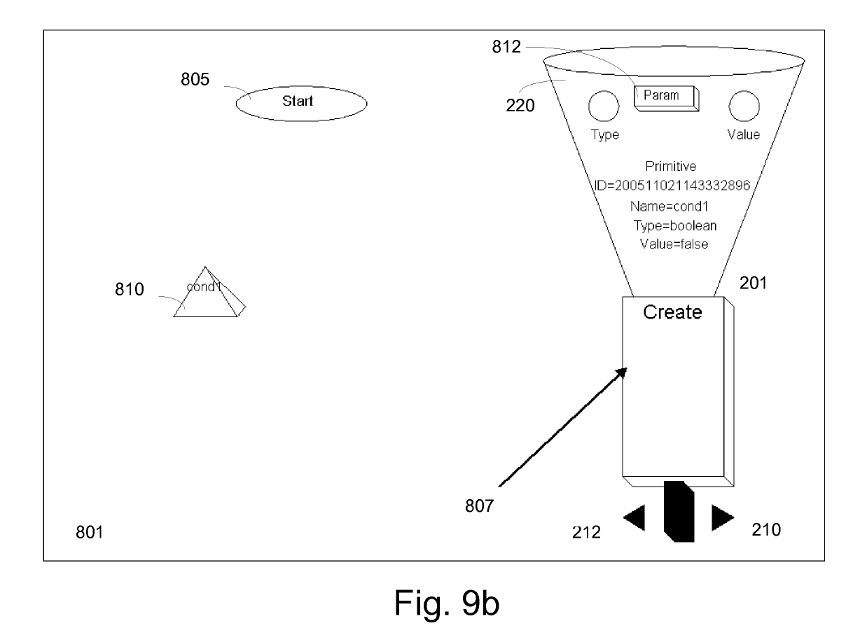

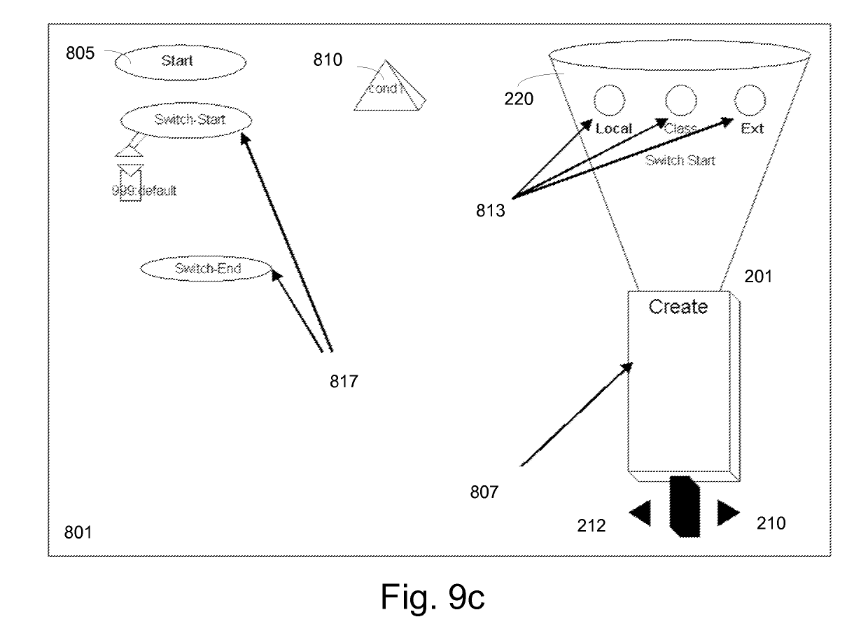

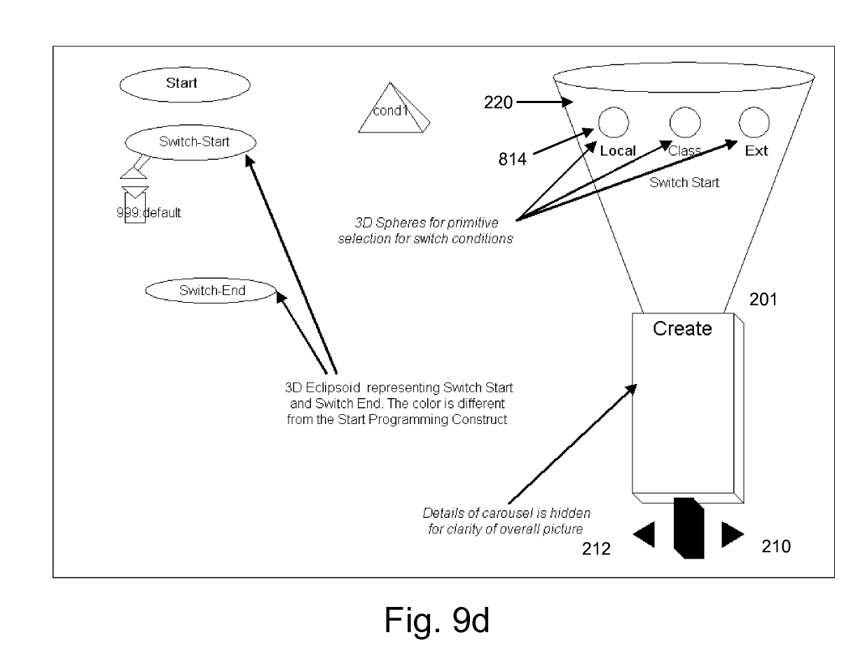

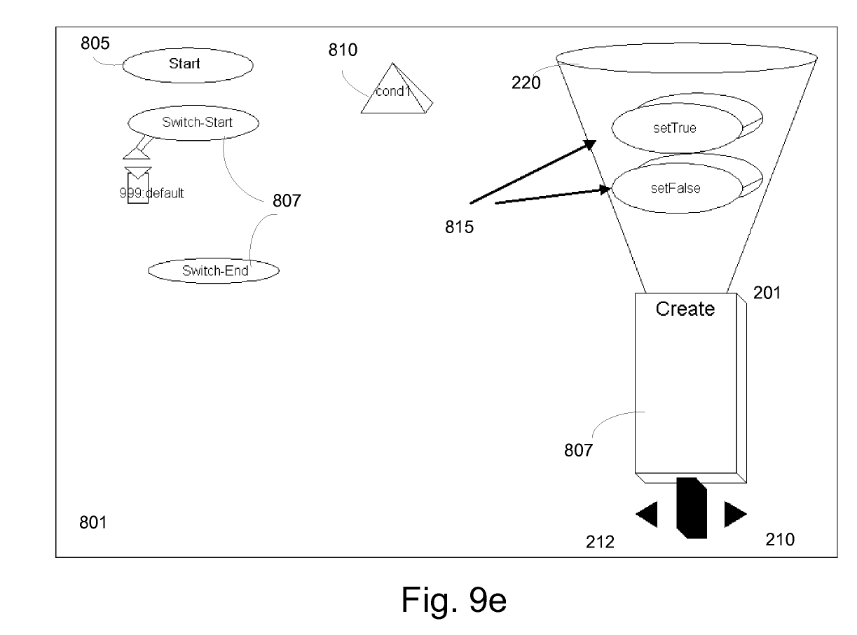

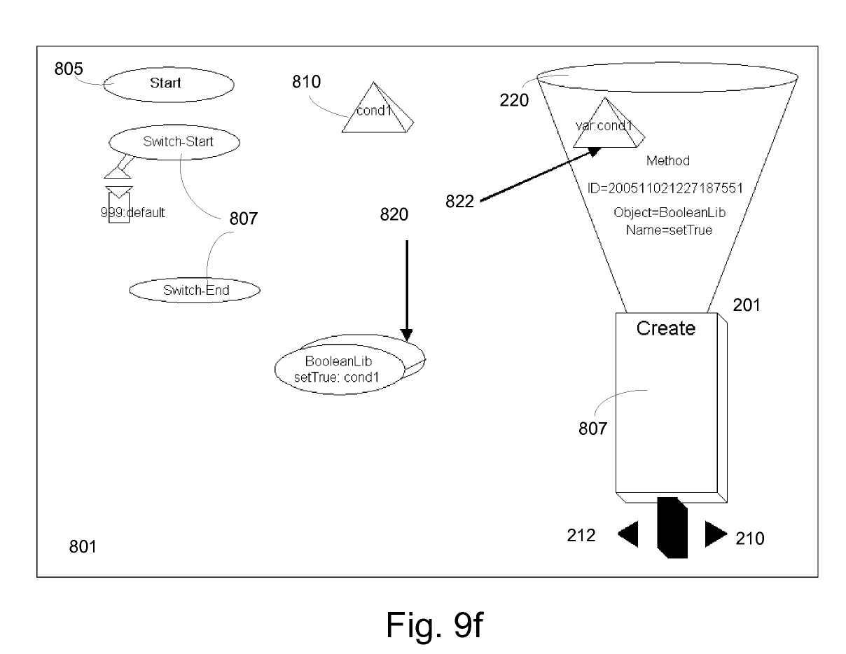

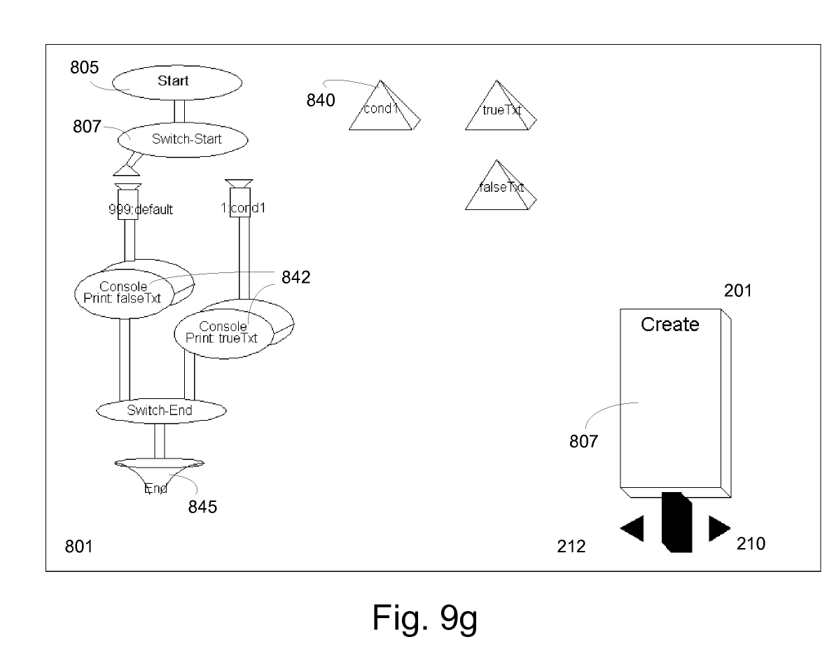

FIG. 9a shows a Method World 801 in accordance with one embodiment of the invention. The Method World provides the programming interface for adding, defining and manipulating primitives and objects. The carousel 201 can be rotated to show the “Create” face 807 for the Method World. In one embodiment, the “Create” face comprises buttons to add, define and manipulate objects and primitives. In one embodiment, local primitives and objects can be created, which exist only within the scope of the method. Besides local primitives and/or objects, parameter primitives and/or objects can also be passed into the method during method calls.

FIG. 9b illustrates the addition of a primitive 810 into the Method 3D World. Initially, the Method World comprises the “Start” programming object 805 to indicate the start of program execution. A primitive can be added by, for example, activating the “Primitive” button (not shown) on the “Create” face 807. In one embodiment, the 3D projection ray 220 displays information about the primitive. Such information include, for example, the unique identifier (ID), the name, type and value of the primitive. In one embodiment, the 3D projection ray comprises a toggle button 812 for toggling between “Local” and “Param” states to define the primitive as a local primitive or a parameter primitive respectively. In the embodiment shown in FIG. 9b, for example, the primitive “condl” 810 is a parameter primitive. Other processes for adding, defining and manipulating primitives and objects in the Method 3D World are similar to those in the Class 3D World.

FIG. 9c shows the addition of a “Switch” programming object 817 in the Method 3D World. The “Switch” programming object allows the branching of control flow (i.e. conditional execution of code logic) based on the conditions encountered during the program execution. In one embodiment, the “Switch” programming object comprises 3 types of elements: Switch-start, Switch-end, and condition elements. The “Switch-start” and “Switch-end” elements 807 define the scope of the “Switch”. The condition element 810 defines the branching conditions. For example, if the default condition is true, the program continues executing along the same pipe labeled “999:default”. The condition element can be labeled by an integer to indicate the priority of execution. For example, smaller integers indicate a higher priority of execution than larger integers. Other methods of indicating priorities are also useful. In the case where there is only one path of execution, fulfilling a condition of higher priority will preclude conditions of lower priorities from being executed, even if their conditions are fulfilled.

In one embodiment, the 3D projection 220 displays information and control buttons for manipulating the programming objects. For example, buttons 813 can be provided for creating additional conditions. In one embodiment, activating the “Local” button will allow the user to select the Boolean primitives from the local Method World. Activating the “Class” will cause the Boolean primitives in the Class to be displayed in the 3D projection for selection. If the “Ext” sphere control is activated, the browsing mechanism will be activated to allow users to choose the Boolean primitives that are external to the Class.

FIG. 9d shows the process of adding a method call language construct in accordance with one embodiment of the invention. The method call language construct allows methods in one object to make method calls into other objects. The method call language construct can be created by activating a “Method Call” button (not shown) on the “Create” face 807.

In one embodiment, the method call language construct is added only after the method has been identified. The method can be identified by using control buttons 814 in the projection ray 220. Activation of the “Local” button, for example, will allow the user to choose the method from local objects in the Method 3D World. Activation of the “Class” button will allow the user to choose from class-level methods. Activation of the “Ext” button will allow the user to browse other 3D Worlds and choose methods external to the class. Referring to FIG. 9e, the 3D projection ray 220 displays the objects and/or methods 815 that are available for the method call when an object is selected.

FIG. 9f shows the selection of the “setTrue” method call programming object 820 as the method call, which is now displayed in the Method 3D World. In one embodiment, parameters 822 of the “setTrue” method are displayed in the 3D projection ray 220. In one embodiment, both the Method Call icon 820 and the Parameter icon 822 are highlighted (e.g., colored in red) to indicate that the parameter values have not been specified. Parameter values can be specified by, for example, activating the corresponding parameter icon in the 3D projection ray and setting the value. For example, in FIG. 9f, the value of the parameter 822 is set to “cond1”.

In one embodiment, control buttons (not shown) are provided in the 3D projection ray for specifying the location of the parameter value. A “Local” button can be provided to allow selection from a local primitive/object in the current Method 3D World. A “Class” button will allow selection of a Class level primitive and/or object. An “Ext” button will enable browsing so that users can choose static external primitive/objects as the parameter value. In one embodiment, after the value of the parameter has been specified, the parameter 3D icon will change to a different color (e.g., green). After all the method parameters had been assigned values, the color of the Method Call 3D icon 820 will change to a different color (e.g., green).

FIG. 9g shows one example of a completed Method definition. The method can be defined to, for example, print different outputs based on the inputted parameter “cond1”. The program flow starts from the “Start” programming object 805. The program then flows to the “Switch-Start” programming object 807. If“cond1” is satisfied (true), program flow will continue along the pipe with the opening labeled “1 :cond1”. Otherwise, the program flow will continue along the default pipe with the opening labeled “999:default”.

If the program flows along the “1 :cond1” pipe, it will flow to the “Print” method 842 of the Console object. The string primitive “trueTxt” is the method parameter that is input to the “Print” method call. If the program flows along the “999:default” pipe, the “Print” method of the Console object will also be activated. However, the string primitive “falseTxt” will be used as the method parameter instead. In either case, the program will flow to the “Switch-End” programming object. Finally the program will complete the method execution at the “End” programming object 845.

Various control buttons can be provided on the “Create” face to manipulate the objects. For example, a “Remove” button can be provided to remove unwanted programming objects created during programming. Other functions can also be provided on the carousel 201. For example, buttons can be provided the process performed within the 3D projection ray, and to navigate between the different worlds.

The programming process is completed after all the necessary packages, classes, objects and methods are defined for the program. In one embodiment, the carousel comprises a “Compile” button for compiling the program. Compilation is the process of converting the program into binary code that can be interpreted and executed by the machine or computer. In one embodiment, compilation comprises at least two steps. The first step converts the graphical icons into the equivalent object-oriented textual program. In one embodiment, the graphical icons are converted into a Java object-oriented textual program. Other types of textual programming language are also useful. The second step converts the object-oriented textual program into binary code. The second step can be implemented using, for example, a java compiler provided in a standard java software development kit (SDK). Other types of compilers, depending on the textual programming language, are also useful.

A method of converting the 3D visual program to an object-oriented textual program in accordance with one embodiment of the invention is disclosed below. Other suitable methods are also useful. As shown, the object-oriented textual program comprises Java. Converting the 3D visual program to other types of object-oriented textual programming languages is also useful.

In one embodiment, a project is converted to a package in equivalent object-oriented programming language based on the project name. Packages are converted to equivalent java packages based on the prefix “pk_” and the package identifier. Hence a package with the name “Pkl” and identifier “Id1” beneath a project with the name “Prj 1” will be converted to ajava package “Prjl.pk_Id1”. During the compilation process, the folder structure of the equivalent java folder structure will be created for the storage of the java files.

For a class, the equivalent java class will have a prefix “Cls_” concentrated with the class identifier. Class modifiers implemented, inheritance inheritance and implemention will be directly translated within the java class. For example, the description in FIG. 5a will translate into the follow Java source code.
public class Cls_{—}200511061637495580 {
public Cls_{—}200511061637495580 ( ){
/** the rest of the items here will be filled in from objects in the Class 3D World */

Objects within the classes are mapped to the Java objects. The name convention will be a prefix “Obj_” followed by the identifier of the object. FIG. 6 is translated into the following code:
//comment
Cls_{—}200511061637495580 Obj_{—}200510301359002722=new Cls_{—}200511061637495580 ( );
note: 200511061637495580 is the identifier for the class, Class1
Objects declared with type “None” will be ignored during compilation.

All classes will have a constructor with no parameter. If none is defined, system will generate one. An object is automatically instantiated using the constructor when it is first allocated a Class type. It is not possible to declare an object to be null.

The primitive creation in FIG. 7a will result in the following code. RainbowVPL.System.Rainbow.Number.BigDecimal Obj_{—}200510301400223152=new RainbowVPL .System.Rainbow.Number.BigDecimal (“0”);

Primitives created in the invention will result in Java objects and not Java primitives. For this reason, the name convention follows that of the object which is “Obj_” followed by the identifier of the primitive. The type mapping between the primitive and the equivalent java class is as follows: String is mapped to RainbowVPL.System.Rainbow.STRING.String which uses the java.lang.String class. Number is mapped to RainbowVPL.System.Rainbow.Number.BigDecimal which uses the java.math.BigDecimal class. Boolean is mapped to RainbowVPL.System.Rainbow.Boolean.BOOLEAN which uses the java.lang.Boolean class. Datetime is mapped to RainbowVPL.System.Rainbow.DateTime.RainbowDateTime which uses the java.util.GregorianCalendar class.

Methods declared in the Class 3D world have no effects unless the corresponding Method 3D World has been completed. The equivalent java method name has the prefix “Mtd_” followed by the method identifier. All equivalent Java methods will return “void”.

Modifier of the methods declared in the Class 3D world will be combined with the parameter primitives/objects for the equivalent java method declaration. FIG. 9b is translated to:
public void Mtd_{—}2005101429420594(RainbowVPL. System.Rainbow.Boolean.BOOLEAN Obj_{—}200511021143332896) {
note: 2005101429420594 is the identifier of the created method.

Switches and process calls in the Method 3D world that are not linked by the pipes will be ignored during the compilation. Switches are converted to the equivalent java if-then-else statements with a label. The reason for the label is because the switches are also used to implement looping. In FIG. 9d, the switch start object is translated to the following: ID_SW20051102113533
do {
   if (false) {/* default empty statement*/}

“20051102113533” is the internal identifier for the switch programming object. The label is required because it is possible for the program to loop back to the start of the switch. When this happens, the following java continue statement will be issued. eg. continue ID_SW20051102113533;

In FIG. 9g, the switch condition object (cond1) is translated as

else if (cond1){

/** the statements here are dependent on the pipe linkage */
break;
}

Additional switch condition object will just be translated to else-if conditions in Java.

The default condition object is translated as

else {

/** the statements here are dependent on the pipe linkage */
break;
}

} while (true);

Switch end object is just to indicate the scope of the switch statements.

Lastly, the method call in FIG. 9F is translated as follows Rainbow.BooleanLib.setTrue(Obj_{—}2005 1102114393);
note: System-level methods do not follow the naming convention used from user created methods.

The invention may be embodied in other specific forms without departing form the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A process for creating an object oriented-type program comprising:
providing a 3-dimensional (3D) visual programming environment for generating the object oriented-type program, wherein the visual programming environment comprises a plurality of 3D worlds associated with respective levels of abstraction within a program hierarchy;
providing a visual programming interface within the visual programming environment, the programming interface includes functions for navigating the plurality of worlds and for creating and manipulating programming objects using pre-defined templates;
creating programming objects using the programming interface, the programming objects specify the object oriented program; and
navigating the plurality of worlds using the visual programming interface.

2. The process of claim 1 wherein programming objects are represented by icons.

3. The process of claim 1 wherein programming objects are represented by 3D icons.

4. The process of claim 1 wherein creating programming objects comprises:
accessing the programming interface;
activating a create function in the programming interface, wherein the programming interface provides a plurality of types of object which can be created; and
selecting one of the plurality of types of objects to be created.

5. The process of claim 1 wherein navigating the plurality of worlds comprises:
accessing the programming interface
activating the navigation function, wherein the programming interface provides a plurality of navigation functions which can be selected; and
selecting one of the navigation functions to navigate the plurality of worlds within the programming environment.

6. The process of claim 1 wherein navigating the plurality of worlds comprises:
selecting an object within the programming environment to navigate into the world containing the selected object; or
selecting one of a plurality of navigation functions provided by the programming interface.

7. The process of claim 1 wherein creating programming objects comprises creating 3D icons representing a programming object

8. A process for creating an object oriented-type program comprising:
providing a visual programming environment for generating the object oriented-type program;
providing a visual programming interface within the visual programming environment for navigation and creating objects using pre-defined templates;
creating a first object of a first type using the visual programming interface, wherein the first object is associated with a first program world; and
creating at least a second object of a second type using the visual programming interface, wherein the second object is associated with the first program world.

9. A programming system comprising:
a 3-dimensional (3D) visual programming environment for generating the object oriented-type program, wherein the visual programming environment comprises a plurality of 3D worlds associated with respective levels of abstraction within a program hierarchy; and
a visual programming interface within the visual programming environment, the visual programming interface comprises functions for navigating the plurality of 3D worlds and creating and manipulating programming objects using pre-defined templates.

10. The programming system of claim 9 wherein programming objects are created with a visual-based programming language.

11. The method of claim 1 further comprises compiling a visual-based program, wherein compiling comprises:
generating objects which specify a program with a visual-based programming language using a visual programming interface;
translating visual objects into a textual-based programming language; and
compiling objects in textual-based programming language into executable code.
